(19) United States
(12) Patent Application Publication
(10) Pub. No.: US 2003/0200996 A1
(43) Pub. Date: Oct. 30, 2003

(54) Method and system for cleaning a wafer chuck

(76) Inventors: William Mark Hiatt, Eagle, ID (US); Karl E. Mautz, Round Rock, TX (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 10/135,119

(22) Filed: Apr. 30, 2002

(51) Int. Cl. B08B 5/04

(52) U.S. Cl. 134/21; 134/26; 134/33; 134/95.1; 134/149

(57) ABSTRACT

The present invention relates to a method of cleaning a wafer chuck (10) by an automated system that supplies a solvent to a chuck surface (12), washes the chuck surface (12), and dries the chuck surface (12) by spinning the chuck (10), in one embodiment. In another embodiment, the chuck surface (12) is dried by pulling a vacuum on the chuck surface (12) or flowing a gas on the chuck surface (12). Additionally, a brush can be used to wash the chuck surface (12).

### FIELD OF THE INVENTION

The present invention generally relates to a method of cleaning a wafer chuck, and more particularly to a method of cleaning a wafer chuck by an automated system. The present invention further relates to an automated system for cleaning a wafer chuck.

### BACKGROUND OF THE INVENTION

It is a common requirement during the processing of semiconductor wafers to maintain a clean environment. For example, cleaning of a substrate before epitaxial growth is an important step in order to remove native oxide and any residual impurities and to obtain a silicon surface with a minimum amount of impurities. However, there are several processes during semiconductor wafer processing in which the wafer is re-contaminated. Such re-contamination may occur, for example, on the upper surface of the wafer, and it would negatively influence subsequent processing.

However, not only the upper surfaces but also the backsides of wafers may become contaminated during processing. Due to the environmental conditions of lithography processing when coating a semiconductor wafer with resist and developing the resist to form a pattern, the backsides of wafers become contaminated by residual resist. Also, this contamination is frequently transferred downstream in the lithographic process and may impact the performance of subsequent processing tools. In particular, defects, for example larger than 1 μm, on the backside of the wafer may seriously effect lithography equipment (i.e. steppers, which are used to expose the resist with a pattern using a reticle). Due to this issue, tracks (tools used for coating and developing) and steppers must be taken out of production on a periodic basis for cleaning, which is performed manually. Such off-line status of the track and the stepper during manual cleaning results in typically one-hour downtime each day. Consequently, there is negative influence on throughput, yield, defectivity, uptime (the amount of time a tool is available for manufacturing as opposed to needing to be maintained or cleaned), cycle time and manufacturing effectiveness. Therefore, a need exists for a method and system to decrease contamination of the backside of wafers without significant tool downtime each day.

### BRIEF DESCRIPTION OF THE DRAWINGS

FIG. 1 is a schematic cross sectional view of a system according to one embodiment of the present invention;

FIG. 2 is a schematic top view of a wafer chuck as a part of the system of FIG. 1; and

FIG. 3 is a flow diagram of a method according to one embodiment the present invention.

### DETAILED DESCRIPTION OF THE PREFERRED EMBODIMENTS

According to one embodiment of the present invention, a method of cleaning a wafer chuck 10 by an automated system is provided, including supplying a washing solvent on a chuck surface 12, washing the chuck surface 12, and drying the chuck surface 12 by spinning the wafer chuck 10.

According to another embodiment of the present invention, there is further provided, in one embodiment, an automated system for cleaning a wafer chuck 10 having a nozzle 14 or sponge 16 for supplying a solvent on a chuck surface 12, a sponge or brush 18 for washing the chuck surface 12, and drying the chuck surface 12 by spinning the wafer chuck 10, applying gas to the wafer chuck, or applying vacuum to (pulling vacuum on) the wafer chuck. In the embodiment where the sponge 16 or the brush 18 is used for washing the chuck surface 12, a mechanical force is applied to the wafer chuck 12 by the sponge 16 or the brush 18.

On the basis of the invention, resist (e.g. photoresist) contamination of a chuck created from coating and developing resist on a semiconductor wafer, which lies on the wafer chuck during the coating and developing process, can be removed to prevent (resist) particle defects on the semiconductor wafer's backside prior to the exposing. The cleanliness of the wafer chuck is maintained, so the potential for pattern distortion during exposure, or contamination of other process tools or handling systems is reduced. Since the (photolithography tool's ability to successfully transfer a pattern will be limited by the cleanliness of the wafer backside, the present invention provides the possibility to achieve better lithography results. For a lithography technology providing structures smaller then 0.18 μm, backside particles may be a major limitation of pattern transfer due to the reduced depth of focus of lithographic tools at these dimensions.

Therefore, the present invention provides benefits to semiconductor processing with respect to throughput, yield, low defectivity, uptime, improved cycle time and manufacturing effectiveness. Additionally, the cleaning process can be formed within the tool and therefore is an in situ wafer chuck cleaning process.

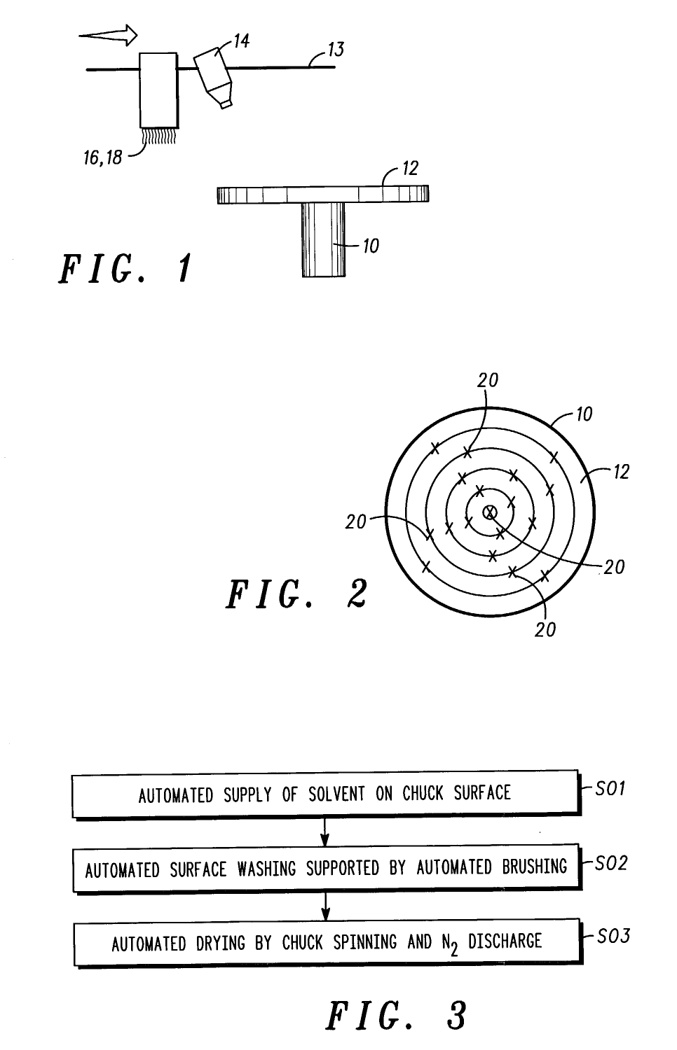

FIG. 1 is a schematic cross sectional view of an automated wafer chuck cleaning system according to one embodiment of the present invention. A wafer chuck 10 having a chuck surface 12, which is a substantially horizontal surface and is used to support semiconductor wafers during processing is shown. The wafer chuck 10 does not presently carry or support a wafer, and is therefore prepared for performing a cleaning method according to the present invention. In other words, a semiconductor wafer is removed from the wafer chuck 10 prior to the process for cleaning the wafer chuck 10 as described below.

The wafer chuck 10 can be made of a metal or metal alloy (i.e. stainless steel), a ceramic material (i.e. silicon carbide), or a hardened plastic (i.e. PolyEther Amide Resin (PEAR)). The wafer chuck 10 can be any type of chuck used in semiconductor manufacturing. For example, the wafer chuck 10 can be a ring-chuck, which is a chuck made of concentric rings so that in cross-section the chuck appears to have a bunch of narrow trenches or deep channels. This type of chuck is typically used in the track tool for lithography processes. Alternatively, a pin-chuck, which is typically used in tools for exposing resist on a semiconductor wafer, can be used. A pin-chuck is a pattern of columns with top portions that form a point (pins). For both ring and pin chucks, gaps are formed between adjacent support structures (rings or pins) for the semiconductor wafer and residue (i.e. resist) often forms or falls in the gaps and needs to be removed.

As shown in FIG. 1, in one embodiment, above the wafer chuck 10 is a coater arm 13, which includes a solvent nozzle 14, and a sponge 16 or a brush (scrubber) 18. In another embodiment, multiple coating arms 13 are present and each one includes different cleaning features. For example, a first coating arm 13 may include the solvent nozzle 14 and a second coating arm 13 may include the sponge 16 or the brush 18. In a preferred embodiment, there is one coating arm 13 which can move (rotate, rastor, etc.) above the chuck surface 12. In one embodiment the coating arm 13 is coupled to a motor (not shown) that is controlled by a computer (not shown) and causes the rotation or restoring (i.e. extension and retraction) of the coating arm 13. The rotation or restoring may be determined by predetermined patterns programmed into the computer. For example, the coating arm 13 may extend over the wafer chuck 10 and begins dispersing a solvent to clean the chuck 10, as described below. To improve the efficiency of the clean process the coating arms 13 may move along a radius of the chuck 10 while spraying the solvent to clean the chuck 10.

In one embodiment, the solvent nozzle can be a topside EBR (edge bead removal) nozzle (currently available in most coating and developing tools and used to remove resist from the edge of wafers) utilized for solvent dispense. Alternatively, an additional nozzle can be added to the coating and developing tools for the solvent nozzle 14 for dispersing a gas, as will be explained below. Hence, in one embodiment, the coating arm may include the solvent nozzle 14 and a separate nozzle and in another embodiment, the coating arm may include one nozzle used for both the solvent and gas applications. The solvent nozzle 14 is used to supply a solvent, which in one embodiment reacts with the resist present on the chuck surface 12 to enable the resist to be easily removed with additional processing to be discussed below. In other words, the solvent may detach the photoresist from the surface of the wafer chuck 10.

In one embodiment, the solvent is organic and, more specifically, is a high-purity acetone. Alternatively, the solvent can be an aldehyde, a ketone or the like. An NMP (n-methyl 2-prrolidone) may be desirable because the vapor pressure of such a chemical decreases the chance of a fire as compared to other chemicals. As a skilled artisan recognizes, safety of the a manufacturing environment is an important factor in choosing chemicals to use in processes and the chance of a fire is one safety hazard that exists.

In one embodiment, the sponge 16 or the brush 18 are used to assist in detaching the photoresist from the chuck surface 12 of the wafer chuck 10. Other means for mechanically cleaning may be provided in addition to or instead of the sponge 16 or the brush or scrubber 18. For example, a swab, cloth, the like, and combinations of the above may be used. These items may be present in addition to the solvent nozzle 14. Alternatively, in order to reduce solvent consumption, a sponge, for example, may be mounted to the coater arm or as a module that is accessible and managed by the coater arm, and used to apply the solvent.

Instead of or in addition to using a solvent, the sponge 16, or the brush 18, gas may be used to detach the photoresist from the chuck surface 12 of the wafer chuck 10. In one embodiment, the gas may be N₂, preferably dry filtered N₂, and may be flown out of a nozzle (gas nozzle), similar to the solvent nozzle 14. Alternatively, dry filtered air or dry filtered oxygen maybe used. The solvent nozzle 14 and the gas nozzle may be controlled together by one coating arms 13 or each may be on separate coating arms 13.

After washing of the chuck surface 12 using a solvent or gas or scrubbing the chuck surface 12 with a brush 18, the chuck surface 12, in one embodiment, can be dried by a high-speed spinning process. The wafer chuck 10 can be rotated or spun by a motor, which may be coupled to the wafer chuck 10. The spinning speed will often be determined based on the wafer size the chuck is designed to support. For example, if the wafer chuck 10 supports wafers that are 300 mm in diameter, the spinning speed may be less than 3000 rpm (rotations per minute), or more preferably less than 2000 rpm. Alternatively, if the wafer chuck 10 supports wafers that are 200 mm in diameter, the spinning speed may be less than 8000 rpm, or more preferably less than 7000 rmp.

Other drying processes or means may be used. For example, as shown in FIG. 2 in one embodiment, vacuum ports 20 may be used for drying the wafer chuck 10. The vacuum ports 20 are usually located along the concentric circles or indentations of the chuck surface 12 and are used to hold a wafer in place with vacuum. However, the vacuum ports 20 may be used to drain any remaining solvent, which may include very small photoresist particles, by providing a vacuum and extruding the solvent through the vacuum port 20 and through the tubes or pipes (not shown) underneath the wafer chuck 10. The solvent or liquid should travel through a tube or pipe to a holding station that is different than the vacuum source in order to prevent contamination of the vacuum source. In a preferred embodiment, the vacuum ports 20 are operated in conjunction with the spinning of the wafer chuck 10 in order to dry the chuck surface 12. In one embodiment, using the vacuum ports 20 and spinning to dry the wafer chuck 10 occurs simultaneously and in another embodiment, they occur serially.

Another method used to dry the chuck surface 12, which can be used alone or in conjunction with the other methods described, is to apply a gas to the chuck surface 12 by using the solvent nozzle 14, the EBR nozzle, or a different nozzle. In one embodiment, the gas is N₂, which is preferably dry filtered in order to minimize particle contamination. Alternately, dry filtered air or dry filtered oxygen can be used. Other gases not mentioned can also be used but would probably have a significantly higher cost than those described above.

FIG. 3 is a flow diagram of a method according to one embodiment of the present invention. In step S01, the solvent is automatically supplied to the chuck surface 12 by utilizing the solvent nozzle 14 or by providing the solvent by a solvent-soaked facility, for example a sponge 16. In step S02, the automatic surface washing cleans the chuck surface 12 of the wafer chuck 10. Brushing with the sponge 16, the brush 18, or other means for mechanically cleaning can support this washing. In step S03 an automated drying is performed. This is achieved by chuck spinning and N₂ discharge. After the wafer chuck 10 is cleaned, a semiconductor wafer is placed on the chuck surface 12, preferably by a robotic arm (not shown), and semiconductor processing, such as depositing a photoresist layer on the semiconductor wafer, is continued.

As should be appreciated by a skilled artisan by now, any of the above processes or combinations of processes may be employed to remove photoresist from the chuck surface 12. In a preferred embodiment, a trial and error method is used which incrementally increases the harshness or complexity of the process used until the photoresist is removed. In one embodiment, the trial and error method is used in development of the process used for a specific tool. In another embodiment, the trial and error method is used each time photoresist is being removed from the chuck surface 12. In one embodiment, the trial and error method includes first trying to detach the photoresist from the chuck surface 12 by using a gas, such as N₂. If the photoresist fails to be detached a second process is used which may include using a solvent and gas. Finally, if the photoresist has not been detached from the chuck surface 12 using the previous methods, applying the solvent and using the sponge 16 or the brush 18 may be used. After using the brush 18, additional solvent and gas may be applied to the wafer chuck 10.

Once the photoresist is detached from the wafer chuck 10, the wafer chuck 10 is dried by any method described above. In a preferred embodiment, the wafer is dried by using a combination of applying vacuum, spinning the wafer chuck 10 and applying a gas, because using all three processes together should decrease the amount of time needed to dry the wafer chuck 10 and, thus, the downtime of the tool. A decrease in downtime of a tool can desirably decrease the overall time for processing a semiconductor wafer, because the amount of time the semiconductor wafer has to wait until the tool is prepared for processing is decreased.

While the invention has been described in terms of particular structures, devices and methods, those of skill in the art will understand based on the description herein that it is not limited merely to such examples and that the full scope of the invention is properly determined by the claims that follow. For example, any number of the vacuum ports 20 can be on the chuck surface 12 and the vacuum ports 20 can be in any configuration. In addition, the process can be used to clean any other objects or parts of a tool that may become contaminated with resist. For example, a spindle which supports the chuck in the tool or shields that are put over the semiconductor wafer to protect the chamber walls of the tool when coating using a liquid (i.e. resist coating) may be cleaned using methods described above. Accordingly, the specification and figures are to be regarded in an illustrative rather than a restrictive sense, and all such modifications are intended to be included within the scope of the present invention.

Moreover, the terms front, back, top, bottom, over, under and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a nonexclusive inclusion, such that a process, method, article, or apparatus that comprises a list of elements does not include only those elements but may include other elements not expressly listed or inherent to such process, method, article, or apparatus.

1. A method of cleaning a wafer chuck by an automated system comprising:
supplying a solvent on a chuck surface, and
drying the chuck surface by a method selected from the group consisting of spinning the wafer chuck, applying gas to the wafer chuck, and applying vacuum to the wafer chuck.

2. The method according to claim 1, wherein the solvent is supplied by an EBR nozzle.

3. The method according to claim 1, wherein the solvent is supplied by means for mechanically cleaning.

4. The method according to claim 1, wherein the solvent is provided by means for mechanically cleaning mounted to a coater arm.

5. The method according to claim 1, wherein the gas is N₂.

6. The method according to claim 1, further comprising removing a semiconductor wafer from the wafer chuck to expose the chuck surface prior to supplying the solvent, and drying the chuck surface.

7. The method according to claim 1, further comprising washing the chuck surface.

8. An automated system for cleaning a wafer chuck comprising:
means for supplying a solvent on a chuck surface,
means for washing the chuck surface, and
means for drying the chuck surface.

9. The automated system according to claim 8, wherein the means for supplying the solvent comprises an EBR nozzle.

10. The automated system according to claim 8, wherein the means for supplying the solvent comprises means for mechanically cleaning.

11. The automated system according to claim 8, wherein the means for supplying the solvent comprises means for mechanically cleaning mounted to a coater arm.

12. The automated system according to claim 8, wherein the means for drying the chuck surface comprises flowing N₂ onto the chuck surface.

13. The automated system according to claim 8, wherein the means for drying the chuck surface comprises spinning the wafer chuck.

14. The automated system according to claim 8, wherein the means for drying the chuck surface comprises pulling a vacuum on the wafer chuck.

15. A method of cleaning a wafer chuck by an automated system comprising the steps of
supplying one of a solvent on a chuck surface,
applying a mechanical force to the chuck surface, and
drying the chuck surface.

16. The method of claim 15, wherein drying the chuck surface is performed by a method selected from the group consisting of spinning the chuck, applying gas to the chuck, and applying vacuum to the chuck.

17. The method of claim 16, wherein the gas is selected from the group consisting of N₂, oxygen and air.

18. The method of claim 16, wherein supplying the solvent on the chuck surface further comprises supplying a gas to the chuck surface.

19. The method of claim 18, wherein the gas is N₂.

20. The method of claim 16, further comprising removing a semiconductor wafer from the wafer chuck to expose the chuck surface prior to supplying the solvent, applying a mechanical force, and drying the chuck surface.
